(19) United States
(12) Patent Application Publication
(10) Pub. No.: US 2019/0170583 A1
(43) Pub. Date: Jun. 6, 2019

(54) DISPLAY DEVICE, AND METHOD FOR CORRECTING DISPLAY STATE OF DISPLAY DEVICE

(71) Applicant: NEC Display Solutions Ltd., Tokyo (JP)

(72) Inventor: Naoki ITAKURA, Tokyo (JP)

(21) Appl. No.: 16/324,512

(22) PCT Filed: Sep. 2, 2016
(86) PCT No.: PCT/JP2016/075812

§ 371 Date: Feb. 8, 2019

(51) Int. Cl. G01J 3/50; G09G 3/3225; G09G 3/36; H05B 33/08

(52) U.S. Cl. CPC G01J 3/50; G09G 3/3225; G09G 3/3648; G09G 2320/0666; G09G 2320/0693; G09G 2320/0653; H05B 33/0845

(57) ABSTRACT

A display device includes: a display device main body including a display panel and a screen calibration function unit that calibrates a display state of the display panel; and a cover that covers the display panel, the cover including an optical sensor in a surface facing the display panel. The optical sensor measures a screen state of the display panel in a state where the display panel is covered with the cover, and sends a measured value of the optical sensor to the display device main body. The screen calibration function unit calibrates the display state of the display panel by using the measured value.

### TECHNICAL FIELD

The present invention relates to a display device and a method for calibrating a display state of a display device.

### BACKGROUND ART

Display devices such as liquid crystal displays and organic EL (electro luminescence) displays have advanced in high definition, high color gamut, and high luminance, and high-value added monitors using these are widely used in industries including photography and printing. Since the state of the light source, the liquid crystal, and the like of the display device deteriorates over time, it is required to maintain and control the display quality. In order to maintain the display state, a so-called monitor calibration operation is performed by using a measuring instrument or by having a built-in optical sensor in the device to re-adjust to a desired brightness or chromaticity (for example, refer to Patent Document 1, Patent Document 2, and Patent Document 3).

To perform a calibration operation, it is necessary to measure the light emitted from the monitor at the center of the screen of the monitor so as to not include external light. For this reason, when a non-contact type measuring instrument is used, it is necessary to prepare a dark room in order to shield external light. However, it is often difficult to prepare a large measurement environment such as a dark room. Therefore, in general, a measurement probe equipped with a light shielding object is arranged in the center of the screen, and light emitted from the monitor is measured. In this case, there is a method for holding the probe that is at the center of the screen with a person's hand or fixating it with a tripod. However, the operation of holding the probe with a human hand or a tripod is cumbersome. Moreover, there is a problem in that that use of the monitor, which is the primary purpose of the monitor, is hindered by arranging the measuring instrument (sensor) or the probe in the center of the screen.

### PRIOR ART DOCUMENTS

### Patent Documents

[Patent Document 1] U.S. Pat. No. 7,391,514
[Patent Document 2] PCT International Publication No. WO 13/179370 pamphlet
[Patent Document 3] Japanese Unexamined Patent Application, First Publication No. 2011-22226

### SUMMARY OF THE INVENTION

### Problem to be Solved by the Invention

As described above, when performing the monitor calibration operation, it is necessary to arrange the measuring probe provided with a light shielding object in the center of the screen, and the method in which the probe is held by a person's hand or is fixated with a tripod, is used. In order to solve such complication, there has been proposed a method of suspending an optical sensor as in Patent Document 1.

However with this method it is necessary to interrupt the use of the monitor, and then install the sensor and perform a calibration operation. Also, since the sensor and the display surface are distanced from each other, it is affected by external light, and since the sensor is not fixated, it is difficult to set the angles of the display surface and the sensor so that they face each other squarely when tilted downward.

On the other hand, as disclosed in Patent Document 2, there has been proposed a method in which a sensor (front sensor) including a light shielding object is arranged in the screen. According to this method, measurement can be performed regardless of changes in the attitude of the monitor.

However, in this method, the sensor part hides the screen display. Therefore in order to reduce the area, the optical sensor and the light shielding object need to be brought close to each other, and the width of the light shielding object needs to be narrowed. The entering external light includes not only direct light and surface reflected light but also external light that enters from the panel surface and that enters by internal reflection. If the width of the light shielding object is narrowed, it becomes more likely to be influenced by external light that enters from the panel surface and that enters by internal reflection.

As with Patent Document 2, Patent Document 3 can follow the changes in the attitude of the monitor. However, if the light shielding hood is narrowed, it becomes more likely to be influenced by external light that enters from the panel surface and that enters by internal reflection. In Patent Document 3, for light shielding it is stated that it is better to take a large light shielding hood arranged around the sensor. However, the dimension of the shielding hood is not clearly specified.

As described above, in Patent Document 2 and Patent Document 3, there is a mode of partially shielding the surroundings of the sensor, and it is not possible to sufficiently shield external light. Disclosed in Patent Document 2 and Patent Document 3 are methods in which the position close to the edge of the screen is measured, the correlation value with respect to the center of the screen is preliminarily stored, and the brightness and the color of the central portion of the screen are predicted by aged deterioration. Therefore, it is necessary on a regular basis to re-correlate with the center due to changes in unevenness in the panel.

In view of the above problems, an object of the present invention is to provide a display device capable of calibrating a monitor screen regardless of changes in the attitude of the monitor and without being influenced by external light, and a method for calibrating a display state of a display device.

### Means for Solving the Problem

In order to solve the above-mentioned problems, a display device according to one exemplary aspect of the present invention includes: a display device main body including a display panel; and a cover that covers the display panel, the cover includes an optical sensor in a surface facing the display panel, the display device main body includes a screen calibration function unit that calibrates a display state of the display panel, the optical sensor measures a screen state of the display panel in a state where the display panel is covered with the cover, and sends a measured value of the optical sensor to the display device main body, and the screen calibration function unit calibrates the display state of the display panel.

A method for calibrating a display state of a display device including a display panel, according to one exemplary aspect of the present invention includes: covering the display panel with a cover; measuring a screen state of the display panel by an optical sensor provided in a surface of the cover, the surface facing the display panel; sending a value measured by the optical sensor to the display device; and calibrating a display state of the display panel.

### Effect of the Invention

According to the present invention, an optical sensor is provided inside a cover, and the cover having the optical sensor is brought into close contact with a display panel. The screen of a monitor is calibrated by using a detection signal of the optical sensor. As a result, the screen of the monitor can be calibrated regardless of the attitude change of the monitor and without being influenced by external light.

### BRIEF DESCRIPTION OF THE DRAWINGS

FIG. 1A is a perspective view showing an appearance configuration of a display device according to a first exemplary embodiment of the present invention.

FIG. 1B is a perspective view showing an appearance configuration of the display device according to the first exemplary embodiment of the present invention.

FIG. 2 is a plan view showing a configuration inside a cover in the display device according to the first exemplary embodiment of the present invention.

FIG. 3A is a plan view used for describing an example of a cover piece in the display device according to the first exemplary embodiment of the present invention.

FIG. 3B is a cross-sectional view used for describing an example of the cover piece in the display device according to the first exemplary embodiment of the present invention.

FIG. 4A is a plan view used for describing another example of the cover piece in the display device according to the first exemplary embodiment of the present invention.

FIG. 4B is a cross-sectional view used for describing the another example of the cover piece in the display device according to the first exemplary embodiment of the present invention.

FIG. 5 is a block diagram showing an internal configuration of the display device main body according to the first exemplary embodiment of the present invention.

FIG. 6 is a plan view showing a configuration inside a cover in a display device according to a second exemplary embodiment of the present invention.

FIG. 7 is a block diagram showing an internal configuration of the display device according to the second exemplary embodiment of the present invention.

FIG. 8 is a plan view showing a configuration inside a cover in a display device according to a third exemplary embodiment of the present invention.

FIG. 9 is a perspective view showing a back-side configuration of the display device according to the third exemplary embodiment of the present invention.

FIG. 10 is a plan view showing a configuration inside a cover in a display device according to a fourth exemplary embodiment of the present invention.

FIG. 11 is a perspective view showing a front-side configuration of the display device main body according to the fourth exemplary embodiment of the present invention.

FIG. 12 is a block diagram showing an internal configuration of the display device main body according to the fourth exemplary embodiment of the present invention.

FIG. 13 is a plan view showing a configuration inside a cover in a display device according to a fifth exemplary embodiment of the present invention.

FIG. 14A is a perspective view of the display device main body according to the fifth exemplary embodiment of the present invention.

FIG. 14B is a perspective view of the display device main body according to the fifth exemplary embodiment of the present invention.

FIG. 15A is a plan view used for describing an example of a cover piece in the display device according to the fifth exemplary embodiment of the present invention.

FIG. 15B is a cross-sectional view used for describing the example of the cover piece in the display device according to the fifth exemplary embodiment of the present invention.

FIG. 16A is an explanatory diagram of another example of attachment between the display device main body and the cover in the display device according to the fifth exemplary embodiment of the present invention.

FIG. 16A is an explanatory diagram of another example of attachment between the display device main body and the cover in the display device according to the fifth exemplary embodiment of the present invention.

FIG. 16C is an explanatory diagram of another example of attachment between the display device main body and the cover in the display device according to the fifth exemplary embodiment of the present invention.

FIG. 17A is a perspective view showing an appearance configuration of a display device according to a sixth exemplary embodiment of the present invention.

FIG. 17B is a perspective view showing an appearance configuration of the display device according to the sixth exemplary embodiment of the present invention.

FIG. 18 is a schematic block diagram showing a basic configuration of the display device according to the present invention.

### EMBODIMENTS FOR CARRYING OUT THE INVENTION

Hereinafter, exemplary embodiments of the present invention will be described with reference to the drawings.

### First Exemplary Embodiment

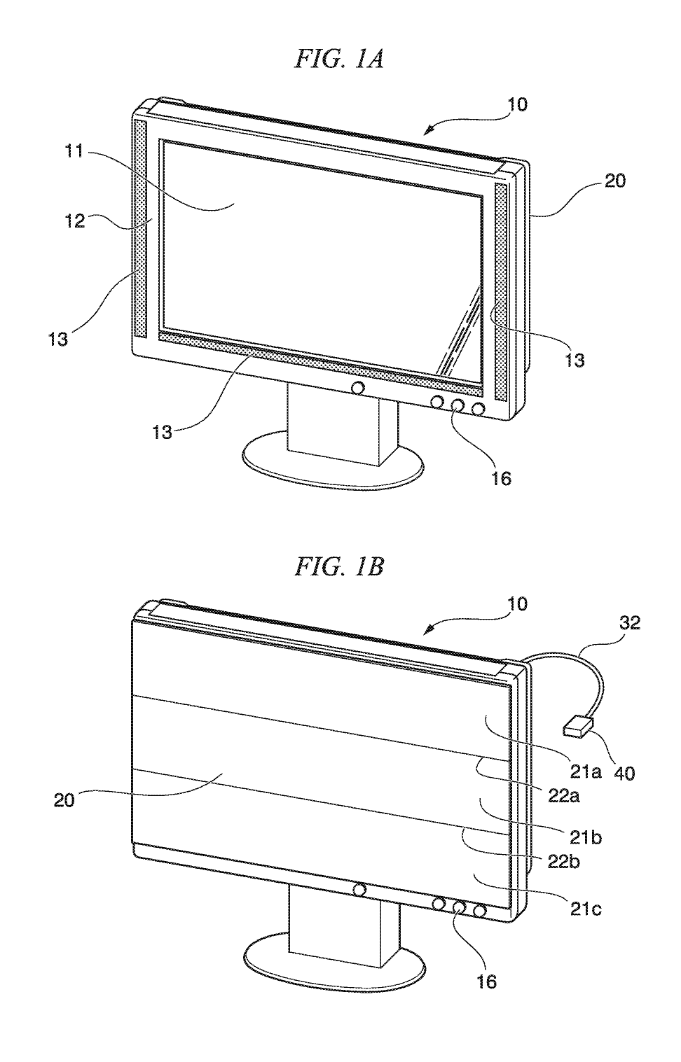

FIG. 1 A and FIG. 1B are perspective views each showing an appearance configuration of a display device according to a first exemplary embodiment of the present invention. FIG. 1A shows a state of a monitor when in use, and FIG. 1B shows a state of the monitor when not in use.

As shown in FIG. 1A, the display device according to the first exemplary embodiment of the present invention includes a display device main body 10 and a light shielding cover 20 attached to the display device main body 10.

The display device main body 10 has a display panel 11. Moreover, the display device main body 10 has a screen calibration function for calibrating the display state of the display panel 11. The display panel 11 is, for example, an LCD (liquid crystal display) panel. On the display device main body 10 there is arranged a display operation and input unit 16. By operating the display operation and input unit 16, as described later, it is possible to set the time and the like for performing brightness calibration of the monitor. This operation may be performed by a remote controller (not shown in the figure). In a bezel 12 of the display device main body 10, there is arranged a magnet attraction material 13 so as to surround the left and right sides and the lower side of the display panel 11. To the upper edge of the display device main body 10 there is attached a cover 20. The magnet attraction material 13 may be any material as long as it is a material that is attracted to a magnet.

The cover 20 is freely foldable, and as shown in FIG. 1A, when the monitor is in use, it is folded and arranged on an upper portion of the back face of the display device main body 10. As shown in FIG. 1B, when the monitor is not in use, the cover 20 is arranged spread out so as to cover the display surface of the display panel 11.

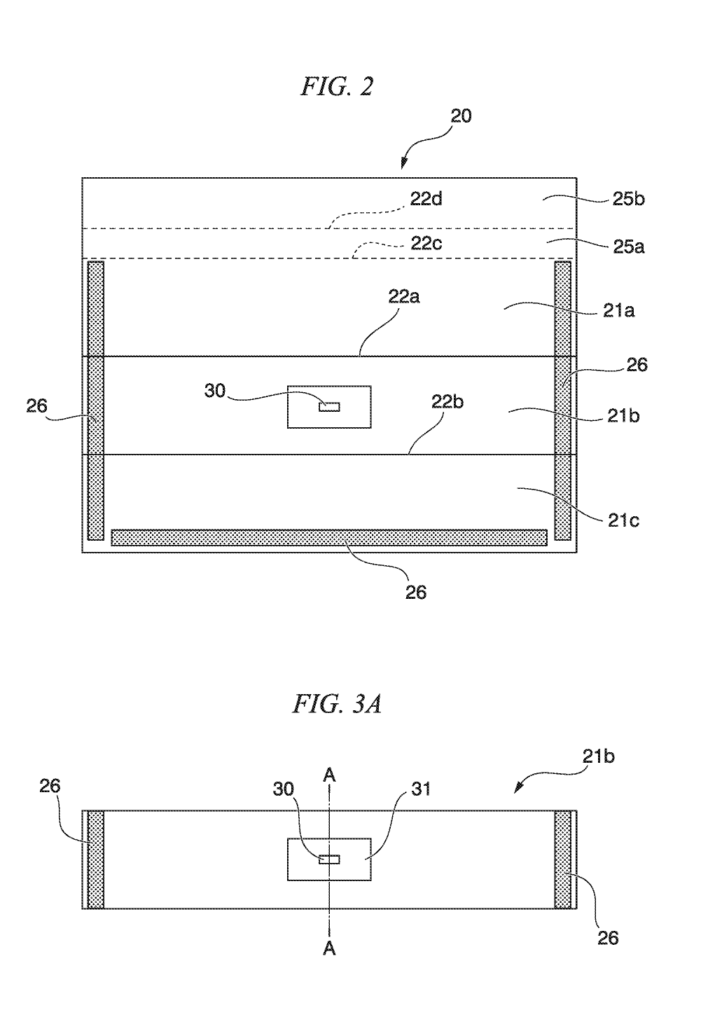

FIG. 2 is a plan view showing a configuration inside the cover 20. As shown in FIG. 2, the cover 20 is of a structure such that three cover pieces 21a, 21b, and 21c are connected via fold portions 22a and 22b. As light shielding members used as the cover pieces 21a, 21b, and 21c, it is preferable to use a material that shields external light (with a light shielding rate of 99.99% or higher in the light shielding property test of a JIS L 1055 black-out curtain). Moreover, magnets (permanent magnets) 26 are arranged inside the three cover pieces 21a, 21b, and 21c. The mounting position of the magnets 26 corresponds to the position of the magnet attraction material 13 (FIG. 1A) of the bezel 12 of the display device main body 10. Further, attachment pieces 25a and 25b are provided on the upper portion of the cover 20 via fold portions 22c and 22d. The attachment piece 25a is a portion to be fixed to the upper edge of the display device main body 10 and the attachment piece 25b is a portion to be fixed to the back face of the display device main body 10. In addition, among the three cover pieces 21a, 21b, and 21c, at the center on the inner side of the center cover piece 21b, there is provided an optical sensor 30.

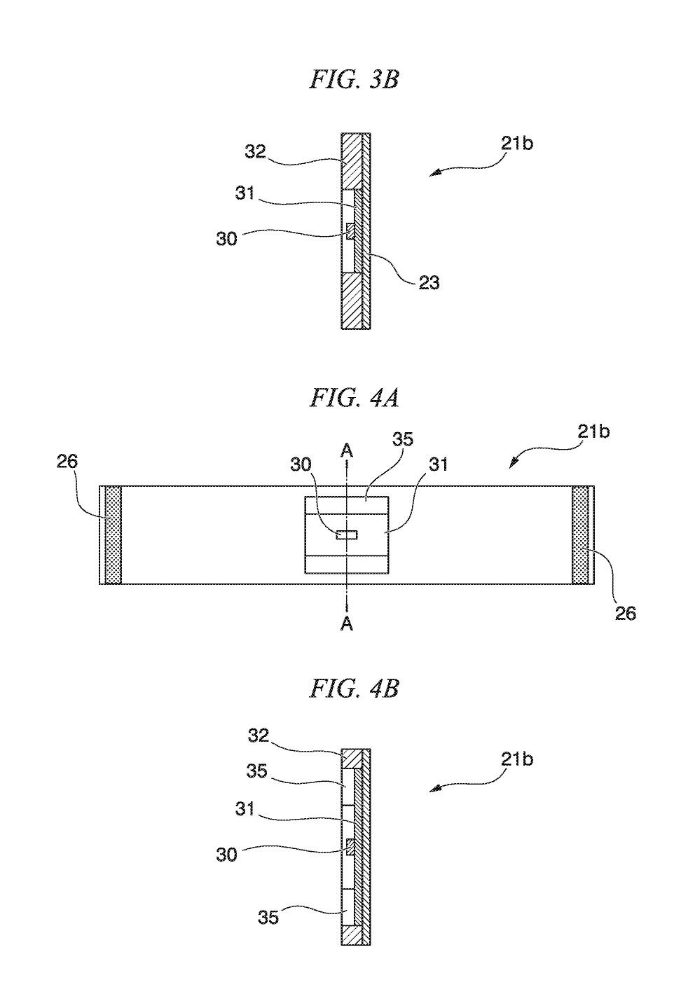

FIG. 3A shows a configuration of the inside of the cover piece 21b (the surface facing the display surface of the display panel 11), and FIG. 3B is a cross-sectional view on A-A′ thereof. As shown in FIG. 3A and FIG. 3B, the optical sensor 30 is arranged on a substrate 31. On the substrate 31 there is mounted a circuit for driving the optical sensor 30. Further, a wiring 32 is led out from the substrate 31. To a distal end of the wiring 32 there is attached a connector 40 (FIG. 1B). In each cover piece 21b there is provided a rigidity maintaining material 23 such as a resin or a steel plate. As described above, in the present exemplary embodiment, the cover 20 includes the rigidity maintaining material 23 such as a steel plate. Therefore, the position of the optical sensor 30 and the position of the display panel 11 are stably maintained.

As shown in FIG. 3A and FIG. 3B, instead of providing the rigidity maintaining material 23 inside the cover piece 21b, a spacer 35 composed of high hardness urethane may be arranged as shown in FIG. 4A and FIG. 4B. With such a spacer 35, it is possible to stably maintain the distance between the position of the optical sensor 30 and the position of the display panel 11.

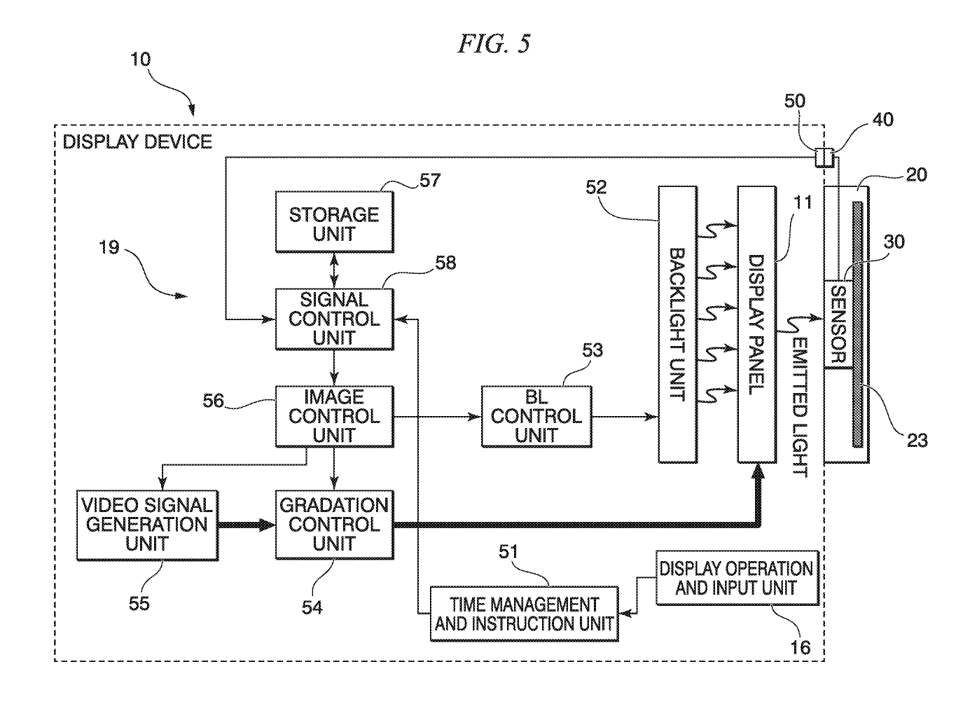

The cover 20 is folded at the fold portions 22c and 22d and is fixed to the display device main body 10 in a state where the positions of the attachment pieces 25a and 25b are in contact with the upper edge and the back face of the display device main body 10. For fixing the attachment pieces 25a and 25b of the cover 20 to the display device main body 10, a double-sided tape or a hook and loop fastener may be used, or a magnet may be used. Further, the connector 40 is connected to a terminal 50 of the display device main body 10 (refer to FIG. 5).

As described above, the cover 20 is of a structure such that the three cover pieces 21a, 21b, and 21c are connected via fold portions 22a and 22b, and is freely foldable at the portions of the fold portions 22a and 22b. As shown in FIG. 1A, the cover 20 is held on the back face of the display device main body 10 and is folded at the portions of the fold portions 22a and 22b when the monitor is in use. In this state, since the display surface of the display panel 11 is exposed to the outside, the user can visually recognize the display screen by displaying an image on the display panel 11. Further, since the cover 20 is held on the back face of the display device main body 10, it does not hinder the user's use.

When the monitor is not in use, as shown in FIG. 1B, the three cover pieces 21a, 21b, and 21c are spread out, and the entire surface of the display surface of the display panel 11 is covered with the cover 20. At this time, the magnets 26 of the cover pieces 21a, 21b, and 21c are attracted to the magnet attraction material 13 of the bezel 12. As a result, the cover 20 is brought into close contact with and fixed on the display surface of the display panel 11. Therefore, the display surface of the display panel 11 is shielded from light by the cover 20, and almost no light from the outside enters onto the display panel 11. That is to say, by shielding the front face of the display surface of the display panel 11 from light by means of the cover 20, not only direct light and surface reflected light but also external light entering from the panel surface and entering by internal reflection are shielded. In this example, a magnet is used to fix the cover 20 to the display panel 11, but the cover 20 may be fixed to the display panel 11 using a hook and loop fastener or the like.

In this manner, in a state where the entire surface of the display surface of the display panel 11 is covered with the cover 20, the screen state of the display device main body 10 is measured using the optical sensor 30, and the calibration operation is performed. This calibration operation can be executed according to a set time schedule.

Next, an internal configuration of the display device main body 10 will be described. FIG. 5 is a block diagram showing an internal configuration of the display device main body 10 according to the first exemplary embodiment of the present invention. Here within the internal configuration of the display device main body 10, only the portions related to a screen calibration function 19 will be described.

As shown in FIG. 5, the display device main body 10 includes the display panel 11, the display operation and input unit 16, a time management and instruction unit 51, a backlight unit 52, a backlight (BL) control unit 53, a gradation control unit 54, a video signal generation unit 55, an image control unit 56, a storage unit 57, and a signal control unit 58.

The time management and instruction unit 51 sets a time schedule for performing the calibration process on the basis of an input from the display operation and input unit 16.

The backlight unit 52 irradiates backlight to the display panel 11 from the back face of the display panel 11. The backlight control unit 53 drives the backlight unit 52 and controls the brightness of the backlight irradiated from the backlight unit 52 to the display panel 11.

The gradation control unit 54 controls the gradation of an image to be displayed on the display panel 11. The video signal generation unit 55 generates a video for performing brightness calibration of the monitor. The image control unit 56 supplies control signals to the backlight control unit 53, the gradation control unit 54, and the video signal generation unit 55, and controls the brightness and gradation of the screen.

The storage unit 57 stores correction adjustment values related to the light quantity and the gradation of the backlight. The signal control unit 58 performs control processing of backlight and gradation by using the correction adjustment values from the storage unit 57 and the detection value of the optical sensor 30 sent via the connector 40 and the terminal 50.

Prior to starting the calibration operation, the user sets a calibration start time. When setting the calibration start time, the user removes the cover 20 from the display surface of the display panel 11, and places the display device main body 10 in a monitor use state as shown in FIG. 1A. Then, the user operates the display operation and input unit 16 to set the calibration start time in the time management and instruction unit 59. Thereafter, as shown in FIG. 1B, the user covers the display panel 11 with the cover 20, and places the display device main body 10 in a monitor unused state.

The time management and instruction unit 51 determines whether or not it is the specified calibration start time. When it is determined that it is the calibration start time, the time management and instruction unit 51 sends a calibration start signal to the signal control unit 58.

Upon receiving the calibration start signal from the time management and instruction unit 51, the signal control unit 58 reads out current correction adjustment values (for example, backlight setting, gradation characteristics, and brightness for each gradation) from the storage unit 57, and sends the adjustment values to the image control unit 56.

Upon receiving the correction adjustment values from the signal control unit 58, the image control unit 56 sets a brightness of the backlight on the basis of the correction adjustment values, and transmits a backlight control signal on the basis of the brightness to the backlight control unit 53. The backlight control unit 53 turns on the backlight unit 52 with the brightness that corresponds to the backlight control signal.

On the other hand, the image control unit 56 instructs the video signal generation unit 55 to generate a video image of the highest gradation at the center of the image, that is, the position that can be detected by the optical sensor 30. The gradation control unit 54 performs gradation control according to the gradation characteristics. The video image from the video signal generation unit 55 has the gradation characteristic thereof adjusted via the gradation control unit 54, and is then sent to the display panel 11 and displayed on the display panel 11.

When the image is displayed on the display panel 11, a detection value is output from the optical sensor 30 according to the brightness of the image on the display panel 11. The detection value of the optical sensor 30 is sent to the signal control unit 58 via the connector 40 and the terminal 50. The detection value of the brightness from the optical sensor 30 is acquired by the signal control unit 58.

The signal control unit 58 sets a target value of the brightness on the basis of the correction adjustment values read out from the storage unit 57 and the gradation adjustment value, and compares the brightness detection value of the optical sensor 30 and the determined target brightness value. Then, the signal control unit 58 determines whether or not the error between the brightness detection value of the optical sensor 30 and the target brightness value exceeds a preliminarily set range.

If the error between the brightness detection value of the optical sensor 30 and the target brightness value exceeds the preliminarily set range, the signal control unit 58 changes the backlight setting value so that the error between the brightness detection value of the optical sensor 30 and the target brightness value becomes smaller. Then, the image control unit 56 sets the brightness of the backlight on the basis of the changed value, and the backlight control unit 53 turns on the backlight unit 52 on the basis of this brightness and repeats the same processing.

By repeating such processing, the brightness value corresponding to the detection value of the optical sensor 30 approaches the target brightness. When the error between the brightness detection value of the optical sensor 30 and the target brightness value falls within the preliminarily set range, the signal control unit 58 stores the correction adjustment values at this time into the storage unit 57, and the processing is finished. With the above processing, the backlight is turned on with the same brightness as the brightness attained when the previously set backlight is turned on, and the brightness of the display device main body is calibrated.

In the above description, the example of calibrating the brightness of the backlight of the display panel 11 has been described. However, by having a constant backlight and replacing the brightness change with a gradation change, it is possible to calibrate the gradation characteristics. Furthermore, if the brightness and gradation are separated into RGB, it can be replaced with color calibration.

As described above, in the display device according to the first exemplary embodiment of the present invention, the cover 20 that widely covers the display surface of the display panel 11 is provided in order to shield external light during measurement. The optical sensor 30 is arranged at the center of the rear surface of the cover 20 (at the center of the surface facing the display surface of the display panel 11 when the cover 20 is covering it) so as to directly face the display surface of the display panel 11. When the monitor of the display device main body 10 is not in use, the display surface of the display panel 11 is covered with the cover 20, and during this time, the screen state of the display device main body 10 is measured using the optical sensor 30 and the calibration operation is performed. As a result, even when no user is present, the brightness calibration of the display device main body can be performed.

Moreover, in the present exemplary embodiment, the cover 20 includes the rigidity maintaining material 23 such as a steel plate, and the cover 20 is fixed in a state of surface contact by means of the magnet 26 or the like. Therefore, it is possible to eliminate intrusion of external light, and maintain the distance between the optical sensor 30 and the display surface of the display panel 11, even when there is an attitude change of the monitor, that is, a vertical and horizontal rotation and/or a tilt angle change, and it is possible to open and close the cover 20 easily. Also, when using the spacer 35 instead of providing the rigidity maintaining material 23, it is possible to stably maintain the distance between the position of the optical sensor 30 and the position of the display panel 11. As a result, stable calibration becomes possible without being influenced by external light and regardless of the orientation or angle of the monitor.

### Second Exemplary Embodiment

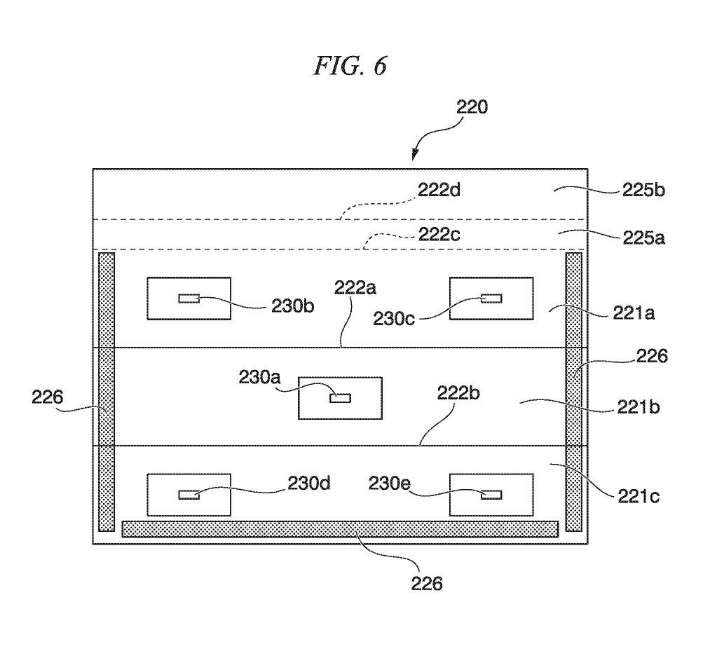

Next, a second exemplary embodiment of the present invention will be described. FIG. 6 shows a configuration inside a cover 220 (a surface facing a display surface of a display panel 11) in a display device according to the second exemplary embodiment of the present invention. In the first exemplary embodiment described above, one optical sensor 30 is arranged at the center of the cover 20. In contrast, in this exemplary embodiment, a plurality of, five in this example, optical sensors 230a to 230e are uniformly arranged. By arranging the plurality of optical sensors 230a to 230e in this manner, uniformity measurement and correction can be performed.

As shown in FIG. 6, the cover 220 is of a structure such that three cover pieces 221a, 221b, and 221c are connected via fold portions 222a and 222b. The optical sensors 230b, 230c are arranged at both of substantially end parts in the longitudinal direction of the cover piece 221a. The optical sensor 230a is arranged at a substantially center portion in the longitudinal direction of the cover piece 221b. The optical sensors 230d, 230e are arranged at both of substantially end parts in the longitudinal direction of the cover piece 221c. In this manner, the optical sensors 230a to 230e are arranged substantially uniformly inside the cover 220. Further, attachment pieces 225a and 225b are provided on the upper portion of the cover 220 via fold portions 222c and 222d. Moreover, inside the cover 220 there is arranged magnets 226 so as to surround the periphery.

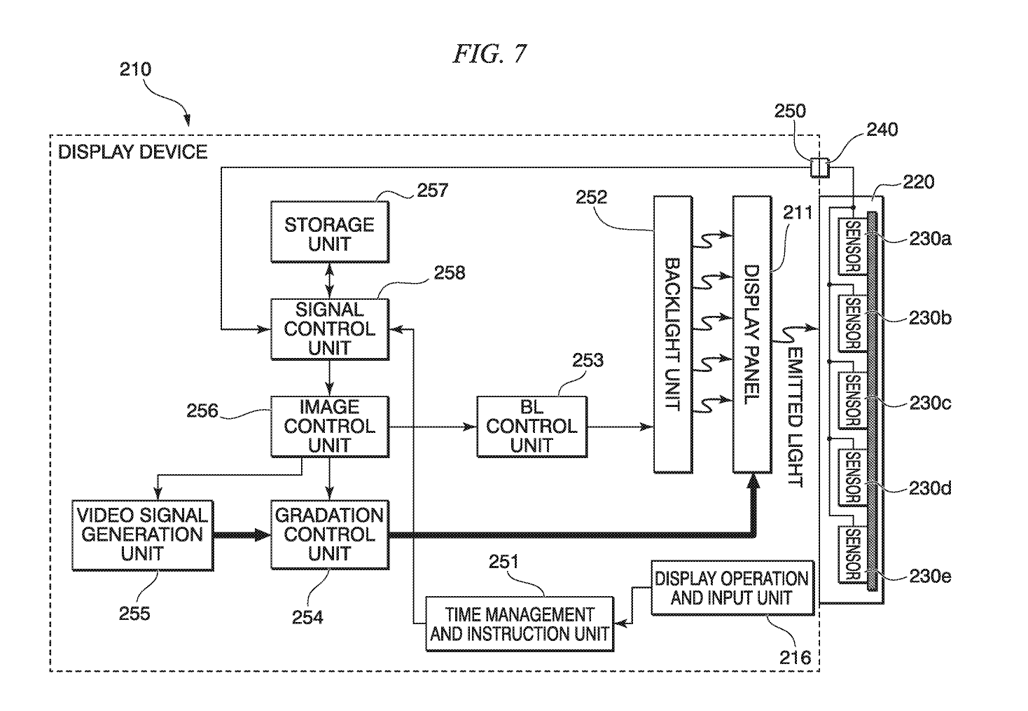

FIG. 7 is a block diagram showing an internal configuration of a display device main body 210 according to the second exemplary embodiment of the present invention. As shown in FIG. 7, the display device main body 210 includes a display panel 211, a display operation and input unit 216, a time management and instruction unit 251, a backlight unit 252, a backlight (BL) control unit 253, a gradation control unit 254, a video signal generation unit 255, an image control unit 256, a storage unit 257, and a signal control unit 258. The display panel 211, the display operation and input unit 216, the time management and instruction unit 251, the backlight unit 252, the backlight control unit 253, the gradation control unit 254, the video signal generation unit 255, the image control unit 256, the storage unit 257, and the signal control unit 258 are similar to the display panel 11, the display operation and input unit 16, the time management and instruction unit 51, the backlight unit 52, the backlight control unit 53, the gradation control unit 54, the video signal generation unit 55, the image control unit 56, the storage unit 57, and the signal control unit 58 in the first exemplary embodiment.

In the present exemplary embodiment, the calibration operation is performed in the state where the entire display panel 211 is covered with the cover 220. At this time, in the present exemplary embodiment, by using the plurality of optical sensors 230a to 230e, uniformity measurement and correction can be performed.

That is to say, when an image is displayed on the display panel 211, detection values are output from the optical sensors 230a to 230e according to the brightness of the image on the display panel 211. The detection values of the optical sensors 230a to 230e are sent to the signal control unit 258 via a connector 240 and a terminal 250.

The signal control unit 258 sets a target value of the brightness on the basis of the correction adjustment values read out from the storage unit 257 and the gradation adjustment value, and compares the brightness detection values of the optical sensors 230a to 230e and the determined target brightness value. Then, the signal control unit 258 determines whether or not the error between the brightness detection values of the optical sensors 230a to 230e and the target brightness value exceeds a preliminarily set range. If the error between the brightness detection values of the optical sensors 230a to 230e and the target brightness value exceeds the preliminarily set range, the signal control unit 258 changes the backlight setting value so that the error between the brightness detection values of the optical sensors 230a to 230e and the target brightness value becomes smaller. Then, the image control unit 256 sets the brightness of the backlight on the basis of the changed value, and the backlight control unit 253 turns on the backlight unit 252 on the basis of this brightness and repeats the same processing. As a result of these operations, the gradation setting for each portion is changed with respect to the previous correction adjustment values. Therefore, brightness uniformity of the display device main body is corrected.

As described above, in the present exemplary embodiment, the plurality of optical sensors 230a to 230e are arranged inside the cover 220. By using the plurality of optical sensors 230a to 230e, uniformity measurement and correction can be performed.

### Third Exemplary Embodiment

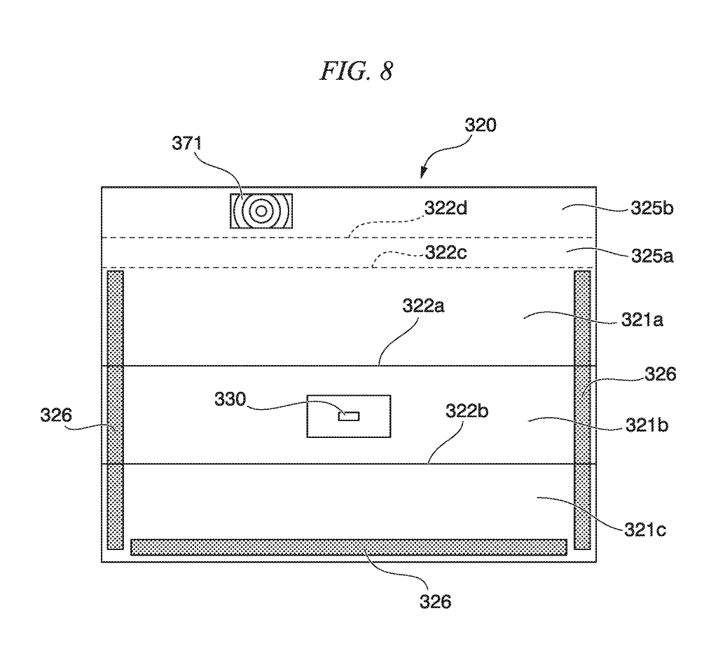

Next, a third exemplary embodiment of the present invention will be described. FIG. 8 shows a configuration inside a cover 320 (a surface facing a display surface of a display panel 11) in a display device according to the third exemplary embodiment of the present invention. In the first exemplary embodiment described above, the connector 40 is led out from the cover 20, and the connector 40 and the terminal 50 are connected to electrically connect the optical sensor 30 and the display device main body 10. In contrast, in this exemplary embodiment, an optical sensor 330 of the cover 320 communicates with the display device main body 310 in a non-contact manner.

As shown in FIG. 8, the cover 320 is of a structure such that three cover pieces 321a, 321b, and 321c are connected via fold portions 322a and 322b. In addition, among the three cover pieces 321a, 321b, and 321c, at the center on the inner side of the center cover piece 321b, there is provided the optical sensor 330. Further, attachment pieces 325a and 325b are provided on the upper portion of the cover 20 via fold portions 322c and 322d. Moreover, inside the cover 320, there is arranged magnets 326 so as to surround the periphery. Furthermore, in the present exemplary embodiment, the attachment piece 325b is provided with a power receiving part 371 for non-contact power feeding. The power receiving part 371 is electrically connected to the optical sensor 330.

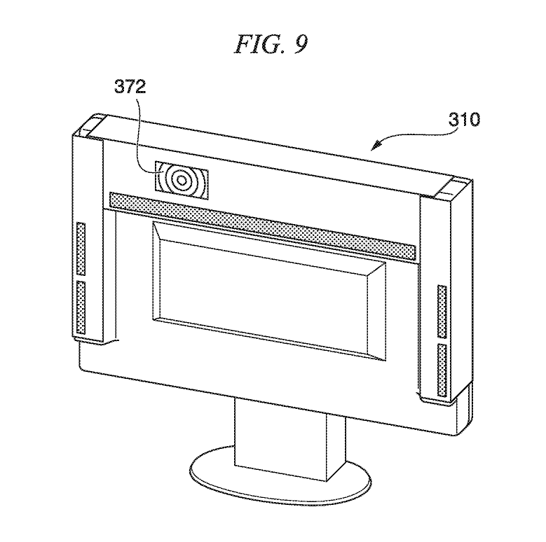

FIG. 9 shows a back face configuration of the display device main body 310. As shown in FIG. 9, a power transmission part 372 for non-contact power feeding is provided on the upper portion of the back face of the display device main body 310. The position of the power receiving part 371 of the cover 320 and the position of the power transmission part 372 of the display device main body 310 correspond to each other. The cover 320 is fixed while the positions of the attachment pieces 325a and 325b are in contact with the upper edge and the back face of the display device main body 310. At this time, the power receiving part 371 of the cover 320 faces the power transmission part 372.

In the first exemplary embodiment described above, the connector 40 is connected to perform communication between the optical sensor 30 and the display device main body 10. On the other hand, in the third exemplary embodiment of the present invention, the power transmission part 372 for non-contact power feeding is provided on the back face of the display device main body 310, and the power transmission part 371 is arranged in the back face of the cover 320 at a position opposite thereto. Thereby, the optical sensor 330 of the cover 320 can communicate with the display device main body 310 in a non-contact manner.

Various types of non-contact power feeding systems are commercially available, and any of them may be used. Here, taking the electromagnetic induction method as an example, the non-contact power transmission part 372 is a coil and an alternating current is passed through the coil to generate an alternating magnetic field. The power receiving power 371 facing the power transmission part 372 is also a coil, and an induced current flows through the power receiving part 371 by the alternating magnetic field of the power transmission part 372 to transmit power. By rectifying this, a direct current power supply is obtained and used as a power supply for the optical sensor 330.

There are various methods for non-contact communication, and any of these methods may be used. As an example of this, there is RFID (radio frequency identification), and there is a communication method standardized by IEC10536. Among them, there are a plurality of methods, and electromagnetic induction is capable of signal transmission by an operation similar to that of the non-contact power feeding, and optical sensor values can be read according to instructions from the main body side. Some non-contact communication methods have a power transmission function, and when this is adopted, the power transmission part 372 and the power receiving part 371 for non-contact power feeding also become unnecessary.

As described above, in the present exemplary embodiment, no connector is required, eliminating the need for the wiring work when attaching the cover. For non-contact power feeding and non-contact communication, a relatively large area is required for antenna wiring patterns for power transmitting/receiving or for signal transmitting/receiving. In the present exemplary embodiment, by using non-contact communication, the space of the back face of the cover can be effectively utilized.

### Fourth Exemplary Embodiment

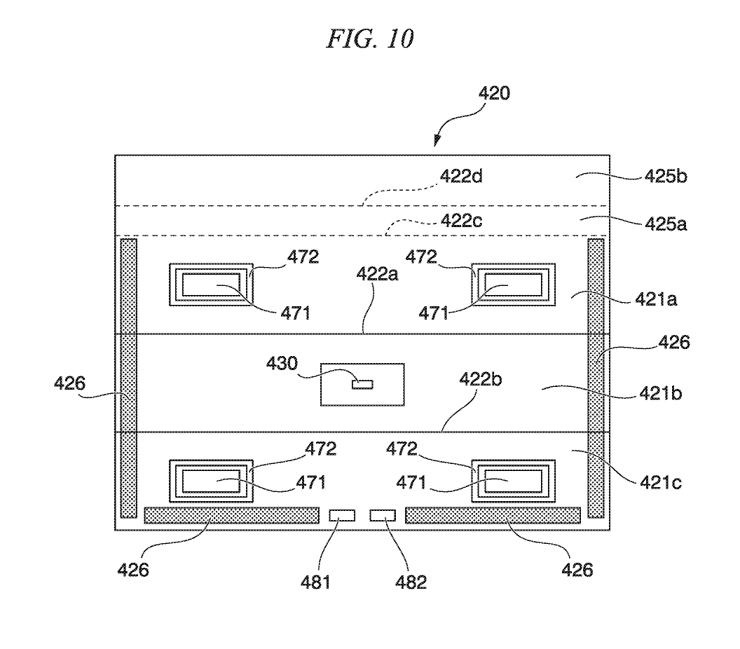

Next, a fourth exemplary embodiment of the present invention will be described. FIG. 10 shows a configuration inside a cover 420 (a surface facing a display surface of a display panel 11) in a display device according to the fourth exemplary embodiment of the present invention. In the first exemplary embodiment described above, the connector 40 is led out from the cover 20, and the connector 40 and the terminal 50 are connected to thereby electrically connect the optical sensor 30 and the display device main body 10. In contrast, in this exemplary embodiment, an optical sensor 430 of the cover 420 communicates with the display device main body 410 by means of optical communication in a non-contact manner.

As shown in FIG. 10, the cover 420 is of a structure such that three cover pieces 421a, 421b, and 421c are connected via fold portions 422a and 422b. In addition, among the three cover pieces 421a, 421b, and 421c, at the center on the inner side of the center cover piece 421b, there is provided the optical sensor 430. Further, on the inner side of the cover 420 there are provided solar cell panels 471. Each solar cell panel 471 is provided with a light shielding object 472 therearound so as not to affect dark portion measurement, and the solar cell panels 471 are arranged at positions away from the optical sensor 430. In this example, four solar cell panels 471 are arranged, but the number of solar cell panels 471 is arbitrary. Further, attachment pieces 425a and 425b are provided on the upper portion of the cover 420 via fold portions 422c and 422d. Inside the cover 420 there is arranged magnets 426 so as to surround the periphery. Furthermore, in the present exemplary embodiment, an optical sensor 481 and an LED (light emitting diode) 482 for communication are provided on the lower edge of the cover 420.

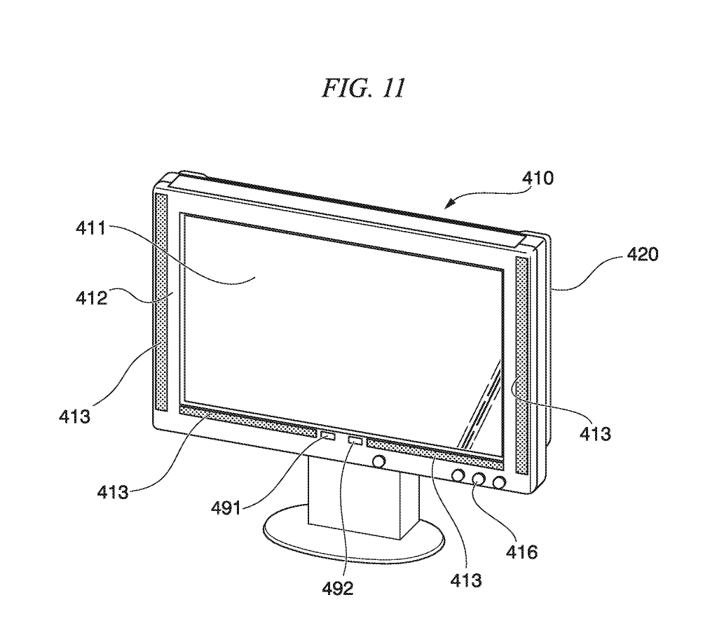

FIG. 11 shows a front-side configuration of the display device main body 410 according to the fourth exemplary embodiment of the present invention. As shown in FIG. 11, the display device main body 410 has a display panel 411. On the display device main body 410 there is arranged a display operation and input unit 416. Moreover, in a bezel 412 of the display device main body 410, there is arranged magnet attraction material 413 so as to surround the display panel 411. On the upper edge of the display device main body 410 there is attached a cover 420. Furthermore, in the present exemplary embodiment, an optical sensor 491 and an LED 492 for communication are provided on the lower edge of the display panel 411.

When the monitor of the display device main body 410 is not in use, the entire surface of the display panel 411 is covered with the cover 420. At this time, the optical sensor 481 and the LED 482 on the lower edge of the cover 420 face the LED 492 and the optical sensor 491 on the lower edge of the display device main body 410. Thereby, the optical sensor 430 can communicate with the display device main body 410 in a non-contact manner. Further, by driving the display panel 411, the solar cell panels 471 generate electricity by light emitted from the display panel 411. This power supply is used to drive the optical sensor 430.

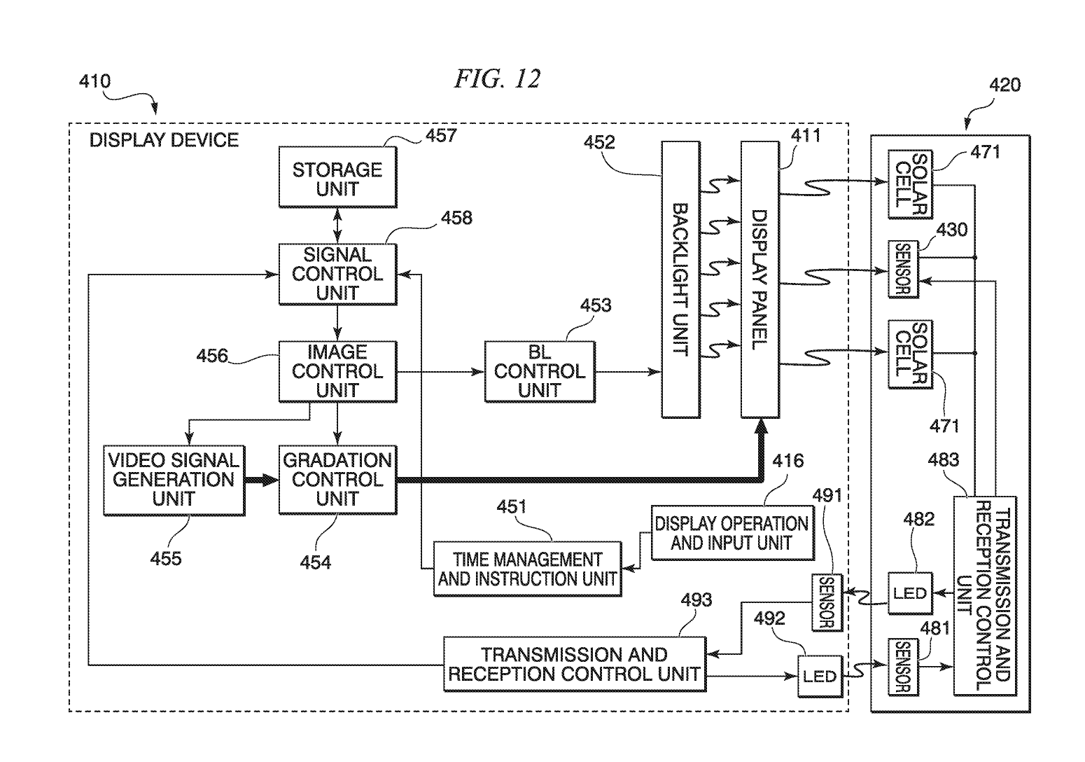

FIG. 12 is a block diagram showing an internal configuration of the display device main body 410. As shown in FIG. 12, the display device main body 410 includes the display panel 411, a display operation and input unit 416, a time management and instruction unit 451, a backlight unit 452, a backlight (BL) control unit 453, a gradation control unit 454, a video signal generation unit 455, an image control unit 456, a storage unit 457, and a signal control unit 458. The display panel 411, the display operation and input unit 416, the time management and instruction unit 451, the backlight unit 452, the backlight control unit 453, the gradation control unit 454, the video signal generation unit 455, the image control unit 456, the storage unit 457, and the signal control unit 458 are similar to the display panel 11, the display operation and input unit 16, the time management and instruction unit 51, the backlight unit 52, the backlight control unit 53, the gradation control unit 54, the video signal generation unit 55, the image control unit 56, the storage unit 57, and the signal control unit 58 in the first exemplary embodiment. Furthermore, in the present exemplary embodiment, the optical sensor 491 and the LED 492 for communication, and a transmission and reception control unit 493 are provided in the display device main body 410.

On the other hand, the cover 420 is provided with the optical sensor 430, the solar cell panels 471, the optical sensor 481 and the LED 482 for communication, and a transmission and reception control unit 483. In a state where the entire surface of the display panel 411 is covered with the cover 420, the optical sensor 491 and the LED 492 of the display device main body 410 face the LED 482 and the optical sensor 481 of the cover 420.

At a calibration start time, a calibration start signal is transmitted from the signal control unit 458. This calibration start signal is sent from the signal control unit 458 to the transmission and reception control unit 493. The calibration start signal is optically modulated by the transmission and reception control unit 493 and output from the LED 492. The output light of the LED 492 is received by the optical sensor 481 on the cover 420 side and demodulated by the transmission and reception control unit 483. As a result, a detection signal is output from the optical sensor 430.

When the detection signal of the optical sensor 430 is transmitted from the cover 420 to the display device main body 410, the detection signal of the optical sensor 430 is supplied to the transmission and reception control unit 483. The detection signal of the optical sensor 430 is optically modulated by the transmission and reception control unit 483 and output from the LED 482. The output light of the LED 482 is received by the optical sensor 491 on the display device main body 410 side, demodulated by the transmission and reception control unit 493, and sent to the signal control unit 458.

Further, in the present exemplary embodiment, solar cell panels 471 are provided on the cover 420. When the display panel 411 is driven in a state where the entire display panel 411 is covered with the cover 420, the solar cell panels 471 generate electricity by light emitted from the display panel 411. The solar cell panels 471 are used as a power supply for the optical sensor 430, the transmission and reception control unit 483, the LED 482, and the optical sensor 481.

As described above, in the present exemplary embodiment, no connector is required, eliminating the need for the wiring work when attaching the cover. Further, by arranging the solar cell panels 471, there is no need to provide a battery or the like.

### Fifth Exemplary Embodiment

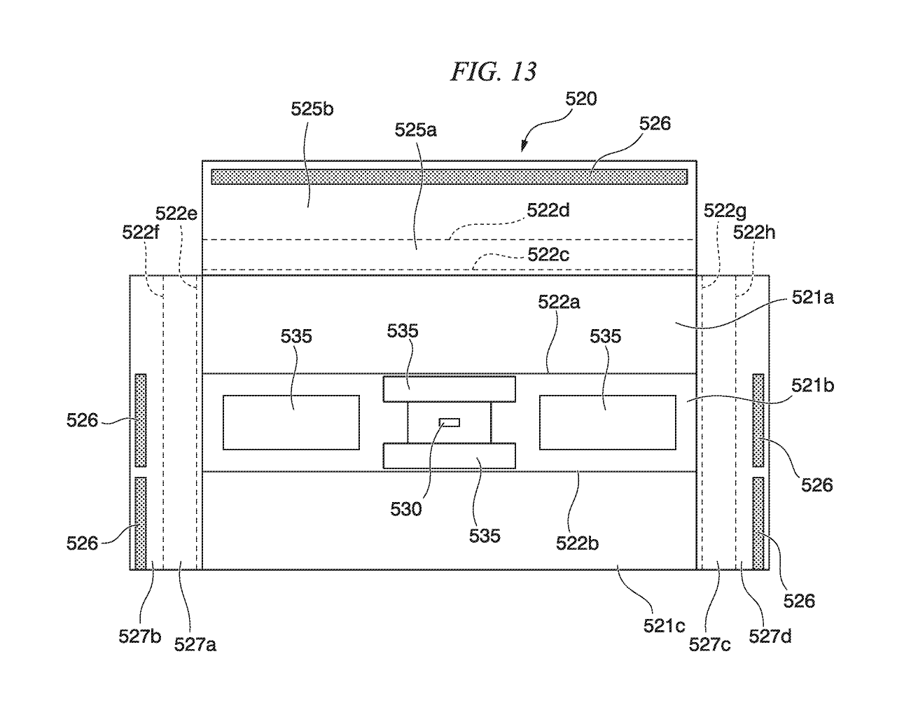

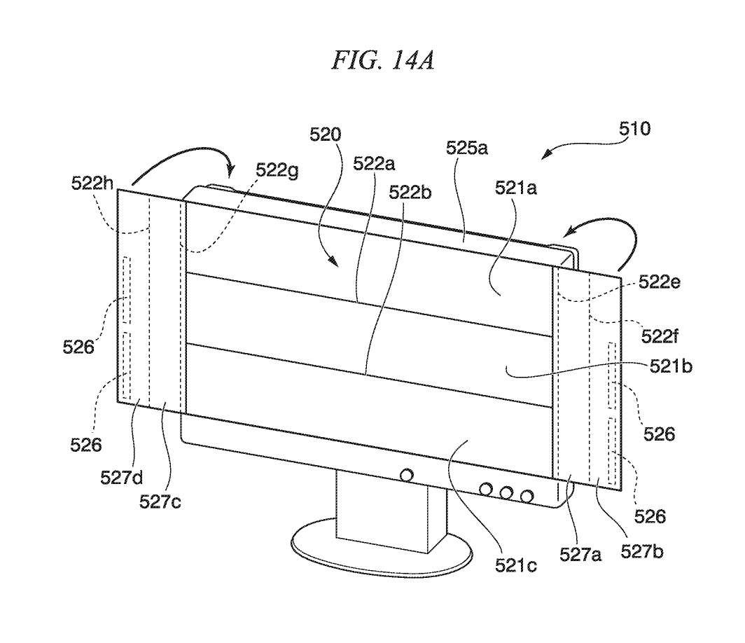

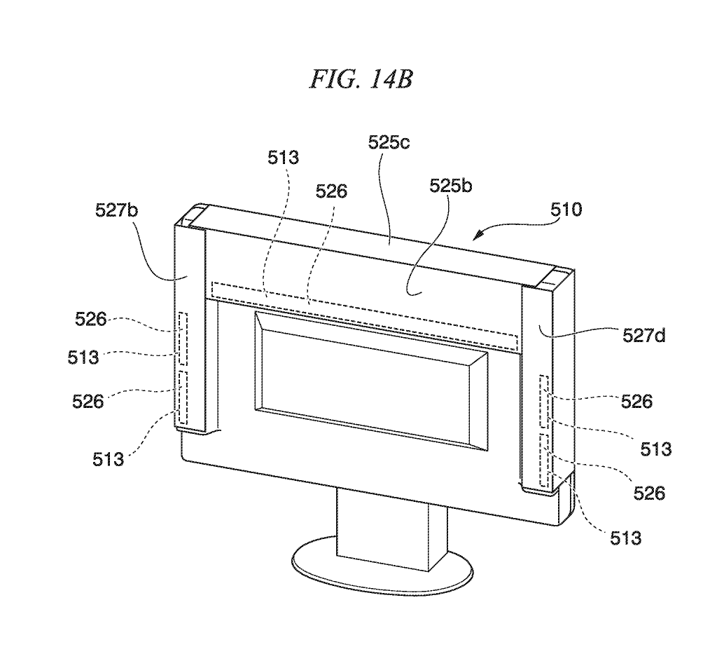

Next, a fifth exemplary embodiment of the present invention will be described. FIG. 13 shows a configuration inside a cover 520 (a surface facing a display surface of a display panel 11) in a display device according to the fifth exemplary embodiment of the present invention. FIG. 14A and FIG. 14B show a state when the cover 520 is attached to the display device main body 510.

As shown in FIG. 13, the cover 520 according to the fifth exemplary embodiment of the present invention is of a structure such that three cover pieces 521a, 521b, and 521c are connected via fold portions 522a and 522b. In addition, among the three cover pieces 521a, 521b, and 521c, at the center on the inner side of the center cover piece 521b, there is provided an optical sensor 530. Further, attachment pieces 525a and 525b are provided on the upper portion of the cover 520 via fold portions 522c and 522d. A magnet 526 is arranged on the attachment piece 525b. Further, the attachment pieces 527a and 527b are provided on the left side of the cover 520 via fold portions 522e and 522f. Attachment pieces 527c and 527d are provided on the right side of the cover 520 via fold portions 522g and 522h. Magnets 526 are arranged on the attachment pieces 527d and 527d on both of the left and right ends.

In the above-described first exemplary embodiment, the magnet attraction material 13 is arranged on the bezel 12. On the other hand, in the present fifth exemplary embodiment, as shown in FIG. 14B, magnet attraction material 513 is provided on the back side of the display device main body 510.

When attaching the cover 520 to the display device main body 510, as shown in FIG. 14A, the cover 520 is attached in a manner such that the display device main body 510 is sandwiched by the attachment pieces 527a and 527b and the attachment pieces 527c and 527d on the left side and the right side of the cover 520. The magnets 526 on both sides of the cover 520 and the magnet attraction material 513 on the back side of the display device main body 510 are attracted to each other to fix the cover 520 to the display device main body 510.

As described above, in the fifth exemplary embodiment of the present invention, the cover 520 is attached in a manner such that the display device main body 510 is sandwiched by the attachment pieces 527a and 527b and the attachment pieces 527c and 527d on the left side and the right side of the cover 520, and the magnets 526 on both sides of the cover 520 and the magnet attraction material 513 on the back side of the display device main body 510 are attracted to each other to fix the cover 520. Therefore, even with a display device main body with a narrow bezel width or a display device main body with no bezel, the screen can be shielded from light and the center of the screen can be measured.

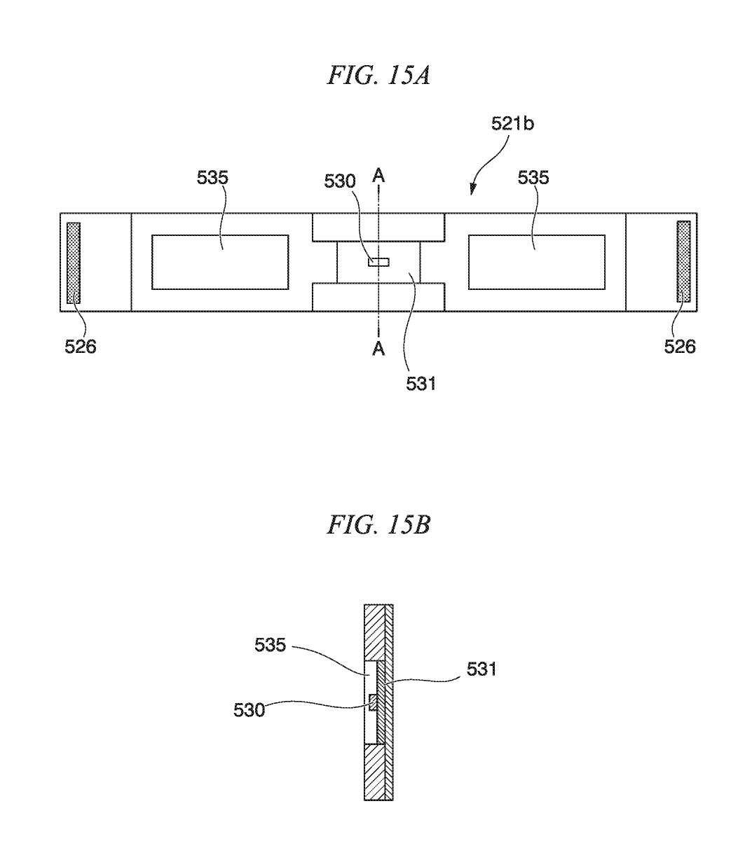

In the fifth exemplary embodiment of the present invention, a tensile force is applied to the cover 520 from the both sides to the rear side. For this reason, as shown in FIG. 15A and FIG. 15B, the area of the spacer 535 is made large. As shown in FIG. 15A and FIG. 15B, the optical sensor 530 is arranged on a substrate 531 and is provided on the cover piece 521b. The spacer 535 is provided in order to stably maintain the distance between the position of the optical sensor 530 and the position of the display panel. In this exemplary embodiment, a spacer having a large area is used as the spacer 535 so that the positional relationship between the position of the optical sensor 530 and the display panel does not change even when a force is applied from both sides.

In the above example, as shown in FIG. 14B, the magnet attraction material 513 is provided on the back side of the display device main body 510, the magnets 526 are provided on the attachment pieces 527b and 527d at the left and right ends of the cover 520, and the cover 520 and the display device main body 510 are fixed with the magnets. The means for fixing the cover 520 and the display device main body 510 is not limited to magnets.

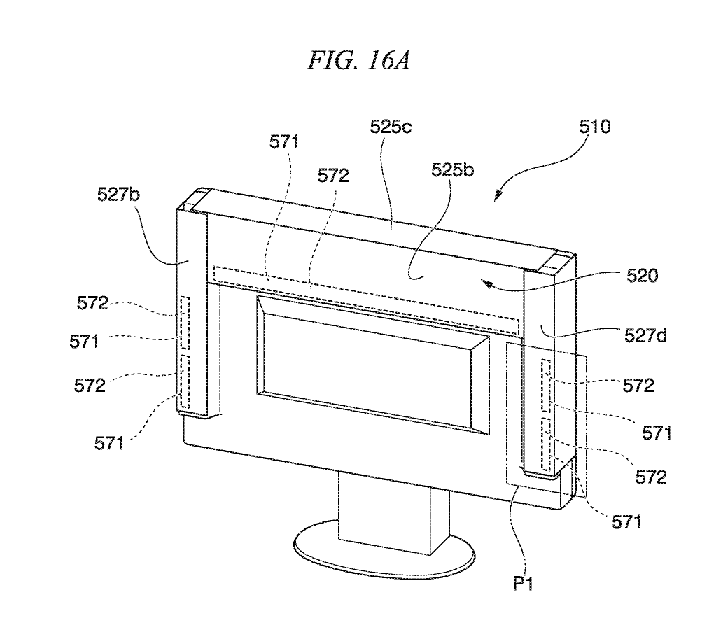

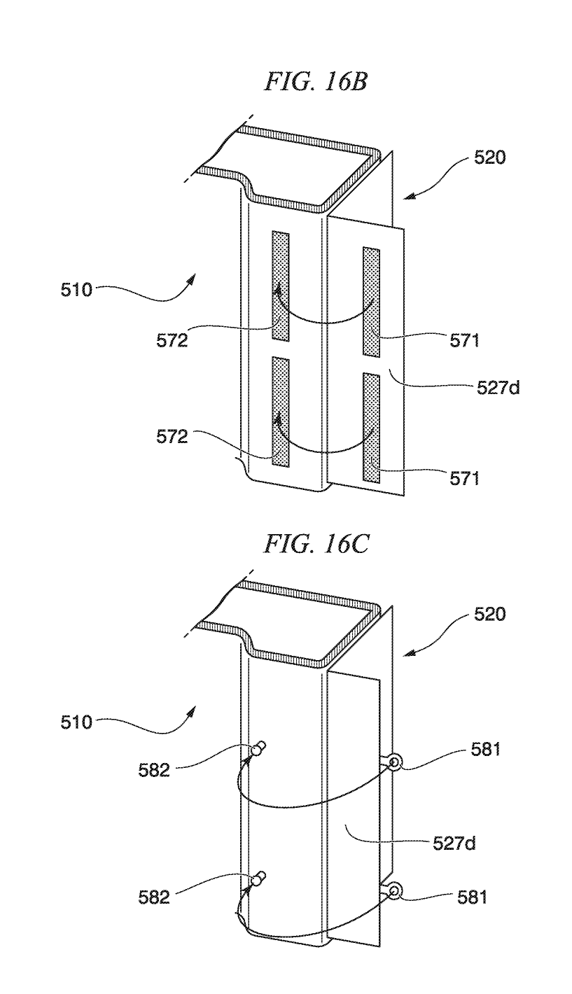

FIG. 16A and FIG. 16B illustrate a manner in which hook and loop fasteners are used to fix the cover 520 and the display device main body 510. Also, FIG. 16B is an enlarged view of the region P1. In FIG. 16A and FIG. 16B, convex side surface fasteners 571 are provided on the attachment pieces 527b, 527d at the left and right ends of the cover 520. On the back side of the display device main body 510, concave side surface fasteners 572 are provided. When attaching the cover 520 to the display device main body 510, the cover 520 is attached in a manner such that the display device main body 510 is sandwiched by the attachment pieces 527a and 527b and the attachment pieces 527c and 527d on the left side and the right side of the cover 520, so that the convex side surface fastener 571 on both sides of the cover 520 and the concave side surface fastener 572 on the back side of the display device main body 510 are coupled to fix the cover 520 to the display device main body 510.

Moreover, as shown in FIG. 16C, the cover 520 may be fixed to the display device main body 510 in a manner such that: hooking hooks 581 are provided on the attaching pieces 527b and 527d at both the left and right ends of the cover 520; protrusions 582 are provided on the back side of the display device main body 510; and the hooking hooks 581 on both sides of the cover 520 and the protrusions 582 on the back side of the display device body 510 are engaged with each other.

In those cases where there is a concern that the magnet's magnetism may affect other devices, or where the monitor main body cannot use magnetism, adopting these attachment methods enables shielding of the screen from light without using magnetism, and enables measurement of the center of the screen.

### Sixth Exemplary Embodiment

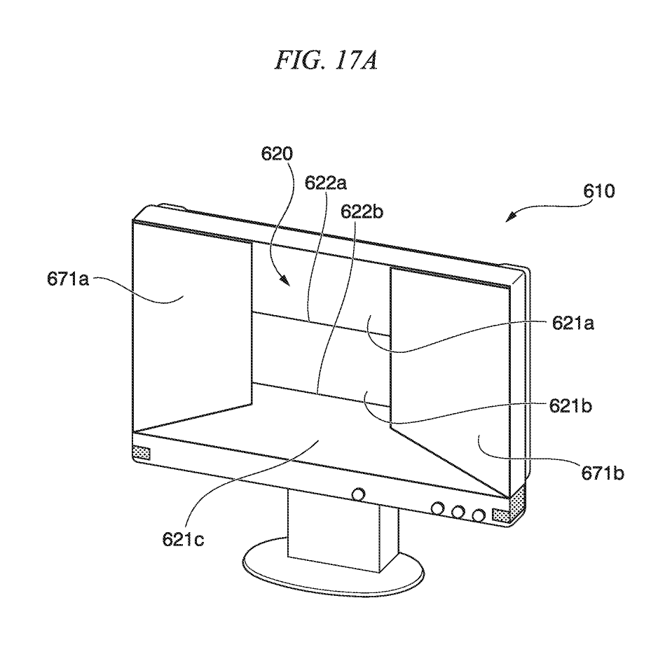

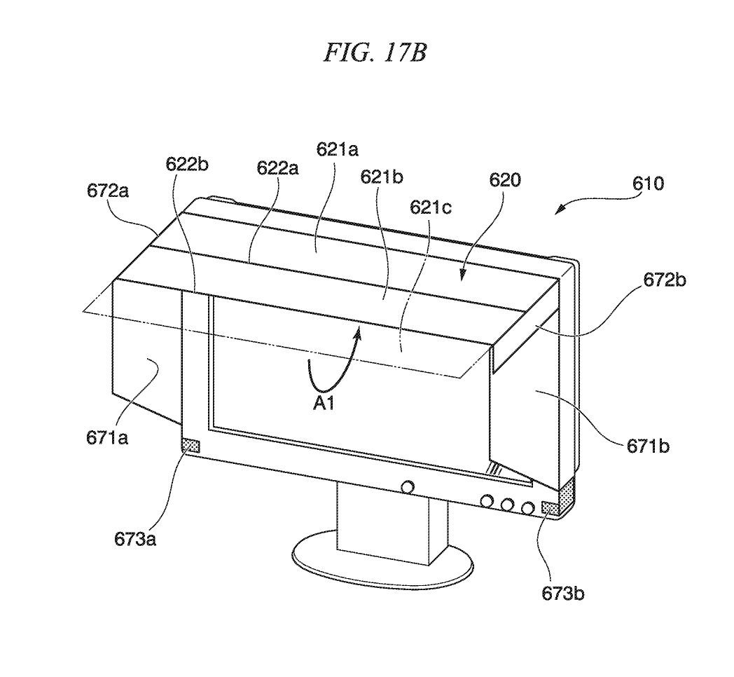

Next, a sixth exemplary embodiment of the present invention will be described. FIG. 17A and FIG. 17B are perspective views each showing an appearance configuration of a display device according to the sixth exemplary embodiment of the present invention. FIG. 17A shows a state of a monitor when not in use, and FIG. 17B shows a state of the monitor when in use.

A cover 620 is of a structure such that three cover pieces 621a, 621b, and 621c are connected via fold portions 622a and 622b. At the center of the inner side of the cover piece 621a there is arranged a light sensor (not shown in the figure). In the present exemplary embodiment, side hoods 671a and 671b are further provided on the left and right sides. Moreover, there are provided skirt portions 672a and 672b that extend in the longitudinal direction of the cover pieces 621a and 621b. The cover 620 is attached to the display device main body 610.

The side hoods 671a and 671b include reinforcing portions 673a and 673b. The reinforcing portions 673a and 673b are provided in order to prevent the side hoods 671a and 671b from shifting backward due to the weights of the cover pieces 621a, 621b, and 621c and the side hoods 671a and 671b when they are opened at the time of using the monitor. In addition, as shown by the arrow A1, the distal end cover piece 621c is folded inward so that the optical sensor arranged on the rear surface of the cover piece 621b is hidden.

In the present exemplary embodiment, a place for housing the cover 620 at the time of using the monitor is not necessary. The cover 620 is intended to shield external light and can be used as a main body hood when using the monitor. Since the cover piece 621c is folded inward when the monitor is in use so that the optical sensor arranged on the rear surface of the cover piece 621b does not receive light, deterioration of the materials caused by ultraviolet rays or visible light can be suppressed. As a result, the optical sensor measurement values are reliable for a longer period of time.

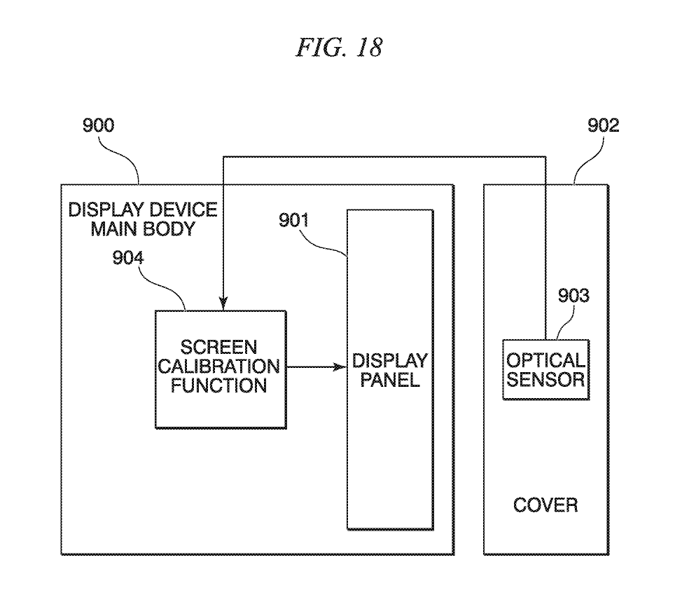

FIG. 18 is a schematic block diagram showing a basic configuration of the display device according to the present invention.

The basic configuration of the display device according to the present invention is as shown in FIG. 18. That is to say, the display device according to the present invention comprises a display device main body 900 having a display panel 901, and a cover 902 that covers the display panel 901. The cover 902 has an optical sensor 903 on the back surface thereof. The display device main body 900 has a screen calibration function 904 for calibrating the display state of the display panel 901. In a state where the cover 902 covers the display panel 901 and shields the display panel 901 from light, the screen state of the display panel 901 is measured by the optical sensor 903, the measured value of the optical sensor 903 is sent to the display device main body 900, and the display state of the display panel 901 is calibrated by the screen calibration function 904.

The present invention is not limited to the above-described exemplary embodiments, and various modifications and applications may be made within a range that does not depart from the gist of the present invention.

### REFERENCE SYMBOLS

10 Display device main body
11 Display panel
12 Bezel
13 Magnet attraction material
19 Screen calibration function
20 Cover
23 Rigidity maintaining material
26 Magnet
30 Optical sensor
35 Spacer

1. A display device comprising:
a display device main body comprising a display panel and a screen calibration function unit that calibrates a display state of the display panel; and
a cover that covers the display panel, the cover comprising an optical sensor in a surface facing the display panel,
wherein the optical sensor measures a screen state of the display panel in a state where the display panel is covered with the cover, and sends a measured value of the optical sensor to the display device main body, and
the screen calibration function unit calibrates the display state of the display panel by-using the measured value.

2. The display device according to claim 1, wherein the screen calibration function unit executes screen calibration processing according to a set time schedule.

3. The display device according to claim 1, wherein the cover comprises a material having rigidity or comprises a spacer between the cover and a display surface of the display panel, and fixes the cover to the display panel.

4. The display device according to claim 3, wherein the cover is fixed to the display panel with a magnet.

5. The display device according to claim 3, wherein the cover is fixed to the display panel by a hook and loop fastener.

6. The display device according to claim 1, wherein the optical sensor is disposed substantially in a center of the surface of the cover that faces the display panel.

7. The display device according to claim 1, wherein the optical sensor comprises a plurality of optical sensors that are arranged in the surface of the cover that faces the display panel.

8. The display device according to claim 1, further comprising:
a connector drawn out from the cover,
wherein the connector is connected to the display device main body, and the optical sensor sends the measured value to the display device main body via the connector.

9. The display device according to claim 1, wherein a signal is input and output by non-contact communication between the cover and the display device main body.

10. The display device according to claim 1, wherein a signal is input and output by optical communication between the cover and the display device main body.

11. A method for calibrating a display state of a display device comprising a display panel, the method comprising:
covering the display panel with a cover;
measuring, by an optical sensor, a screen state of the display panel in a state where the display panel is covered with the cover, the optical sensor being provided in a surface of the cover, the surface facing the display panel;
sending, by the optical sensor, a measured value of the optical sensor to the display device; and
calibrating a display state of the display panel by using the measured value.
